(19) United States
(12) Patent Application Publication
(10) Pub. No.: US 2026/0066553 A1
(43) Pub. Date: Mar. 5, 2026

(54) CONNECTION STRUCTURE AND METHOD OF MANUFACTURING CONNECTION STRUCTURE

(71) Applicant: yazaki Corporation, Tokyo (JP)

(72) Inventors: Kazuyoshi KAGAMI, Shizuoka (JP); Shingo OKUBO, Shizuoka (JP)

(73) Assignee: yazaki Corporation, Tokyo (JP)

(21) Appl. No.: 19/312,635

(22) Filed: Aug. 28, 2025

(30) Foreign Application Priority Data
Sep. 4, 2024 (JP) 2024-152403

(51) Int. Cl. H01R 4/02; H01R 25/16; H01R 43/02

(52) U.S. Cl. CPC H01R 4/027; H01R 25/162; H01R 43/0263

(57) ABSTRACT

A connection structure includes a first connection member including a first conductor and a second connection member including a second conductor, wherein the first conductor includes a first base portion and a first thin portion, the second conductor includes a second base portion and a second thin portion, a thickness of the first thin portion is smaller than that of the first base portion throughout a width direction of the first conductor, a thickness of the second thin portion is smaller than that of the second base portion throughout the width direction of the second conductor, and a first connection surface and a the second connection surface contact with each other to connect the first connection member and the second connection member to each other.

### CROSS-REFERENCE TO RELATED APPLICATIONS

The present application is based on, and claims priority from Japanese Patent Application No. 2024-152403, filed on Sep. 4, 2024, the entire contents of which are incorporated herein by reference.

### TECHNICAL FIELD

The present disclosure relates to a connection structure and a method of manufacturing a connection structure.

### BACKGROUND

When bus bars used in electric vehicle batteries or the like are connected to each other, conductor parts overlap with each other, resulting in an increase in thickness of a connection part between the bus bars. Thus, in the related art, it has been known to form an engaging groove in the bus bar.

JP2017-195109 A1 discloses a bus bar including a first joining member having an engaging groove provided to be recessed so that counter surfaces facing each other in a direction intersecting with an overlapping direction are defined and a second joining member having an engaging piece inserted into the engaging groove. The first joining member and the second joining member are ultrasonically joined to each other between the engaging groove and the engaging piece. In JP2017-195109 A1, the configuration described above suppresses an increase in thickness of the joint part in the bus bar.

### SUMMARY OF THE INVENTION

In the bus bar described in JP2017-195109 A1, the engaging piece of the second joining member is inserted into the engaging groove of the first joining member, and ultrasonic joining is performed therebetween. Thus, the connection direction of the first joining member and the second joining member is fixed, and the connection angle therebetween cannot be adjusted freely.

The present disclosure has been made in view of such problems in the related art. Further, an object of the present disclosure is to provide a connection structure and a method of manufacturing a connection structure that can freely adjust a connection angle between a first connection member and a second connection member while suppressing an increase in thickness of a connection part between the first connection member and the second connection member.

A connection structure according to an aspect of the present disclosure includes a first connection member including a first conductor and a second connection member including a second conductor. The first conductor is a bus bar. The first conductor includes a first base portion and a first thin portion being continuously connected to the first base portion on the same plane and having a thickness smaller than that of the first base portion. The second conductor includes a second base portion and a second thin portion being continuously connected to the second base portion on the same plane and having a thickness smaller than that of the second base portion. A shape of the second thin portion as viewed in a length direction of the second conductor is a rectangular shape. The first thin portion is provided at a distal end of the first conductor, and a thickness of the first thin portion is smaller than that of the first base portion throughout a width direction of the first conductor. The second thin portion is provided at a distal end of the second conductor, and a thickness of the second thin portion is smaller than that of the second base portion throughout a width direction of the second conductor. The first thin portion includes a first connection surface arranged on a plane different from a surface of the first base portion. The second thin portion includes a second connection surface arranged on a plane different from a surface of the second base portion. The first connection surface and the second connection surface contact with each other to connect the first connection member and the second connection member to each other.

A method of manufacturing a connection structure according to another aspect of the present disclosure includes preparing a first connection member including a first conductor and a second connection member including a second conductor, and connecting the first connection member and the second connection member to each other. The first conductor is a bus bar. The first conductor includes a first base portion and a first thin portion being continuously connected to the first base portion on the same plane and having a thickness smaller than that of the first base portion. The second conductor includes a second base portion and a second thin portion being continuously connected to the second base portion on the same plane and having a thickness smaller than that of the second base portion. A shape of the second thin portion as viewed in a length direction of the second conductor is a rectangular shape. The first thin portion is provided at a distal end of the first conductor, and a thickness of the first thin portion is smaller than that of the first base portion throughout a width direction of the first conductor. The second thin portion is provided at a distal end of the second conductor, and a thickness of the second thin portion is smaller than that of the second base portion throughout a width direction of the second conductor. The first thin portion includes a first connection surface arranged on a plane different from a surface of the first base portion. The second thin portion includes a second connection surface arranged on a plane different from a surface of the second base portion. In the connection structure, the first connection surface and the second connection surface contact with each other to connect the first connection member and the second connection member to each other.

According to the present disclosure, it is possible to provide a connection structure and a method of manufacturing a connection structure that can freely adjust a connection angle between a first connection member and a second connection member while suppressing an increase in thickness of a connection part between the first connection member and the second connection member.

### BRIEF DESCRIPTION OF DRAWINGS

FIG. 1 is a perspective view illustrating an example of a state before a first connection member and a second connection member are connected to each other.

FIG. 2 is a plan view illustrating an example of the state before the first connection member and the second connection member are connected to each other.

FIG. 3 is a side view of the first connection member or the second connection member as viewed in a length direction.

FIG. 4 illustrates an example of a state after the first connection member and the second connection member are connected to each other.

FIG. 5 illustrates another example of the state after the first connection member and the second connection member are connected to each other.

### DETAILED DESCRIPTION OF THE INVENTION

With reference to the drawings, a connection structure and a method of manufacturing a connection structure according to the present embodiment are described below in detail. Note that the dimensional ratios in the drawings are exaggerated for explanatory purposes, and may be different from the actual ratios.

### [Connection Structure]

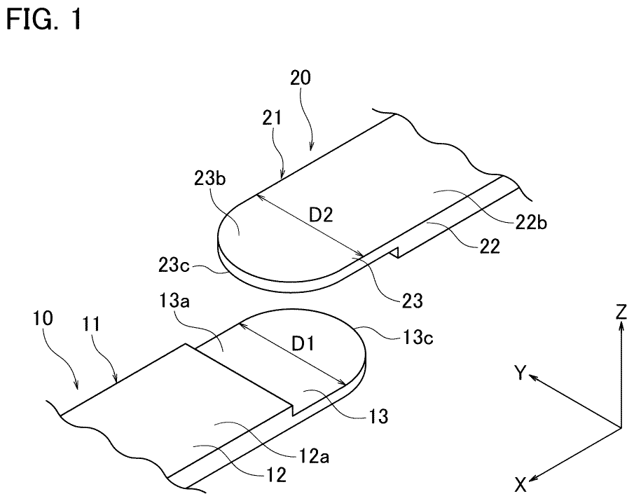

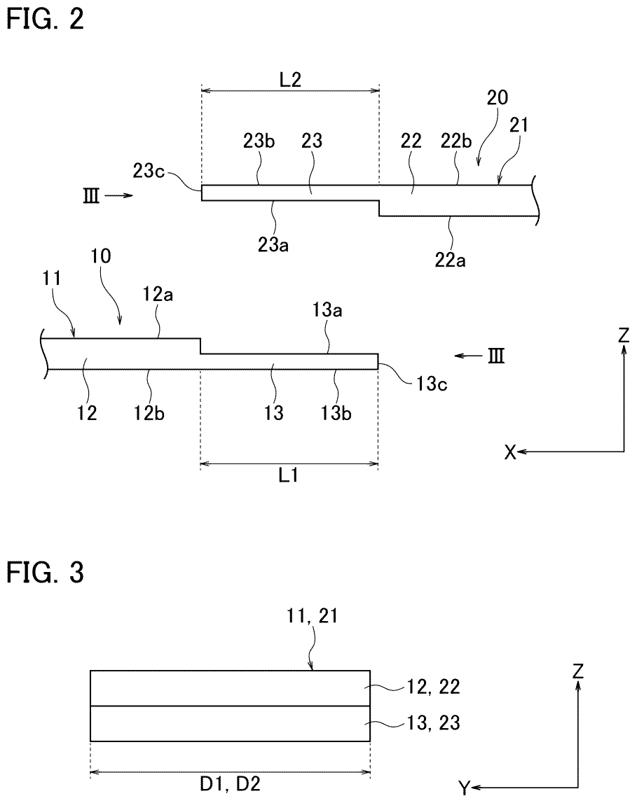

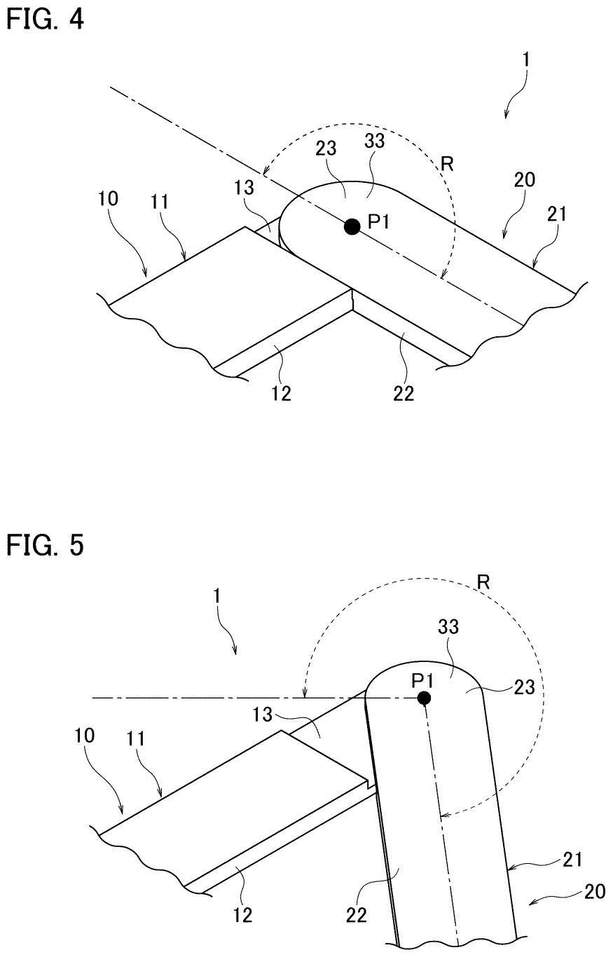

First, with reference to the drawings, a connection structure 1 according to the present embodiment is described. FIG. 1 is a perspective view illustrating an example of a state before a first connection member 10 and a second connection member 20 are connected to each other. FIG. 2 is a plan view illustrating an example of the state before the first connection member 10 and the second connection member 20 are connected to each other. FIG. 3 is a side view of the first connection member 10 or the second connection member 20 as viewed in a length direction X. FIG. 4 illustrates an example of a state after the first connection member 10 and the second connection member 20 are connected to each other. Note that, in this specification, description is made while a length direction, a width direction, and a thickness direction of the first connection member 10, a first conductor 11, the second connection member 20, or a second conductor 21 are referred to as a direction X, a direction Y, and a direction Z, respectively.

As illustrated in FIG. 1 to FIG. 4, the connection structure 1 according to the present embodiment includes the first connection member 10 and the second connection member 20. In the present embodiment, the shape of the first connection member 10 and the shape of the second connection member 20 are the same, but may be different from each other. The first connection member 10 includes the first conductor 11. The second connection member 20 includes the second conductor 21. In the connection structure 1, the first connection member 10 and the second connection member 20 are connected mechanically and electrically to each other.

The first conductor 11 is a bus bar. The bus bar may include a flat conductor having a rectangular cross-sectional shape. The bus bar may be coated by an insulating coating material containing an insulating material. For example, the first connection member 10 may include the first conductor 11 being a bus bar and an insulating coating material (omitted in illustration) coating the first conductor 11.

The second conductor 21 may be a bus bar or an element wire bundle including a plurality of element wires. When the second conductor 21 is a bus bar, the second conductor 21 may be the same as or different from the first conductor 11. For example, the shape of the second conductor 21 may be the same as or different from the shape of the first conductor 11. Further, the material of the second conductor 21 may be the same as or different from the material of the first conductor 11. The second connection member 20 may include the second conductor 21 being a bus bar and an insulating coating material (omitted in illustration) coating the second conductor 21.

The second connection member 20 may be an electric wire, and may include the second conductor 21 being an element wire bundle and an insulating coating material (omitted in illustration) coating the outer periphery of the second conductor 21. The element wire bundle includes a plurality of element wires, and may be configured by bundling the plurality of element wires. The end portion of the element wire bundle may be formed into a plate-like shape by crimping the plurality of element wires together at the end portion of the element wire bundle. The plurality of element wires may include a compact stranded wire formed by bundling a plurality of element wires. Further, the element wire bundle may be formed of one compact stranded wire, or may be a composite stranded wires formed by bundling a plurality of compact stranded wires.

In view of material cost and heat generation during conduction, each of the plurality of element wires preferably contains copper or aluminum. The material of each element wire may be, for example, copper, aluminum, or an alloy containing those types of metal. In view of weight reduction, each of the plurality of element wires is preferably formed of aluminum or an aluminum alloy.

The insulating coating material coating the bus bar may contain a resin. In view of bendability, insulation properties, withstand voltage properties, heat resistance, and applicability to automobiles, the insulating coating material coating the bus bar preferably contains a resin containing a polyamide such as polyamide 12 (PA12).

As the insulating coating material coating the plurality of element wires, a thermoplastic resin capable of ensuring electrical insulation may be used. The insulating coating material may include, for example, at least one of an olefin-based resin and polyvinyl chloride. The olefin-based resin may include, for example, at least one resin selected from the group consisting of polyethylene (PE), polypropylene (PP), ethylene copolymers, and propylene copolymers.

The first conductor 11 includes a first base portion 12 and a first thin portion 13. The first base portion 12 has a rectangular cross-sectional shape vertical to the length direction X of the first conductor 11, and extends in the length direction X of the first conductor 11. The first base portion 12 may be coated by an insulating coating material.

The first thin portion 13 is continuously connected to the first base portion 12 on the same plane. The first thin portion 13 is provided at the distal end of the first conductor 11. Further, the first thin portion 13 has a thickness smaller than that of the first base portion 12. Specifically, the thickness of the first thin portion 13 is smaller than that of the first base portion 12 throughout the width direction Y of the first conductor 11.

The thickness of the first thin portion 13 may be 10% or more, 20% or more, 30% or more, 40% or more, or 50% or more of the thickness of the first base portion 12. Further, the thickness of the first thin portion 13 may be 90% or less, 80% or less, 70% or less, 60% or less, or 50% or less of the thickness of the first base portion 12. As the thickness of the first thin portion 13 is increased, the rigidity of the first thin portion 13 can be increased. Further, as the thickness of the first thin portion 13 is reduced, a thickness of a connection part 33 can be reduced when connected to a second thin portion 23. When the first connection member 10 includes the insulating coating material, the insulating coating material at the end portion of the first connection member 10 is peeled off to expose the first thin portion 13.

The first base portion 12 includes a first surface 12a and a second surface 12b arranged on a side opposite to the first surface 12a in the thickness direction Z. The first thin portion 13 includes a first connection surface 13a and a first non-connection surface 13b arranged on a side opposite to the first connection surface 13a in the thickness direction Z. The first connection surface 13a is arranged on a plane different from the first surface 12a of the first base portion 12. The first non-connection surface 13b is arranged on the same plane as the second surface 12b of the first base portion 12. The first surface 12a and the first connection surface 13a are oriented in the same direction. Further, the second surface 12b and the first non-connection surface 13b are oriented in the same direction. Further, a step is provided between the first base portion 12 and the first thin portion 13.

The second conductor 21 includes a second base portion 22 and the second thin portion 23. The second base portion 22 extends in the length direction X of the second conductor 21. The second base portion 22 may be coated by an insulating coating material. The second base portion 22 may have a rectangular cross-sectional shape vertical to the length direction X of the second conductor 21, or may have a circular cross-sectional shape. The thickness of the second base portion 22 may be 70% or more, 80% or more, or 90% or more of the thickness of the first base portion 12. The thickness of the second base portion 22 may be 130% or less, 120% or less, or 110% or less of the thickness of the first base portion 12.

The second thin portion 23 is continuously connected to the second base portion 22 on the same plane. The second thin portion 23 is provided at the distal end of the second conductor 21. The second thin portion 23 has a thickness smaller than that of the second base portion 22. Specifically, the thickness of the second thin portion 23 is smaller than that of the second base portion 22 throughout the width direction Y of the second conductor 21.

The thickness of the second thin portion 23 may be 10% or more, 20% or more, 30% or more, 40% or more, or 50% or more of the thickness of the second base portion 22. Further, the thickness of the second thin portion 23 may be 90% or less, 80% or less, 70% or less, 60% or less, or 50% or less of the thickness of the second base portion 22. As the thickness of the second thin portion 23 is increased, the rigidity of the second thin portion 23 can be increased. Further, as the thickness of the second thin portion 23 is reduced, the thickness of the connection part 33 can be reduced when connected to the first thin portion 13. When the second connection member 20 includes the insulating coating material, the insulating coating material at the end portion of the second connection member 20 is peeled off to expose the second thin portion 23.

The second base portion 22 includes a first surface 22a and a second surface 22b arranged on a side opposite to the first surface 22a in the thickness direction Z. The second thin portion 23 includes a second connection surface 23a and a second non-connection surface 23b arranged on a side opposite to the second connection surface 23a in the thickness direction Z. The second connection surface 23a is arranged on a plane different from the second surface 22b of the second base portion 22. The second non-connection surface 23b is arranged on the same plane as the second surface 22b of the second base portion 22. The second surface 22b and the second connection surface 23a are oriented in the same direction. Further, the second surface 22b and the second non-connection surface 23b are oriented in the same direction. Further, a step is provided between the second base portion 22 and the second thin portion 23.

In the connection structure 1, the first connection surface 13a and the second connection surface 23a contact with each other to connect the first connection member 10 and the second connection member 20 to each other. The thickness of the connection part 33 at which the first thin portion 13 and the second thin portion 23 are connected to each other is smaller than the total thickness of the first base portion 12 and the second base portion 22. The thickness of the connection part 33 may be 50% or more, 70% or more, or 90% or more of the thickness of the first base portion 12 or the thickness of the second base portion 22. The thickness of the connection part 33 may be 130% or less, 110% or less, or 100% or less of the thickness of the first base portion 12 or the thickness of the second base portion 22.

For example, the thickness of the first base portion 12 is made equal to the thickness of the second base portion 22. Further, when the thickness of the first thin portion 13 is set to half of the first base portion 12, and the thickness of the second thin portion 23 is set to half of the second base portion 22, the thickness of the connection part 33 is equal to the thickness of the first base portion 12 or the thickness of the second base portion 22. In this manner, when the first connection member 10 and the second connection member 20 overlap with each other and are connected to each other, an increase in thickness of the connection part 33 can be suppressed.

As illustrated in FIG. 3, the shape of the second thin portion 23 as viewed in the length direction X of the second conductor 21 is a rectangular shape. With such a shape, the connection between the first thin portion 13 of the first conductor 11 being a bus bar and the second thin portion 23 can be facilitated.

The first thin portion 13 includes a first arc portion 13c. The second thin portion 23 includes a second arc portion 23c. Specifically, the first thin portion 13 and the second thin portion 23 each have an arc shape. Due to the first arc portion 13c and the second arc portion 23c, the distal end of the first thin portion 13 can be prevented from interfering with the second base portion 22, and the distal end of the second thin portion 23 can be prevented from interfering with the first base portion 12 as compared to a case in which the distal end has a rectangular shape in plan view. For example, the connection angle between the first connection member 10 and the second connection member 20 can be easily adjusted by easily rotating the first connection surface 13a of the first thin portion 13 and the second connection surface 23a of the second thin portion 23 while keeping them in contact.

As described above, in the related art, the method of connecting the first connection member and the second connection member is limited to ultrasonic joining. However, according to a method of manufacturing the connection structure 1 according to the present embodiment, the connection method is not limited to such a mode, and the first connection member 10 and the second connection member 20 can be connected to each other by various methods. Specifically, the first connection surface 13a and the second connection surface 23a may be connected to each other by welding. Welding may be pressure joining such as ultrasonic welding and resistance welding, or a combination thereof.

A length L1 of the first thin portion 13 may be equal to or larger than a width D1 of the first thin portion 13, and a length L2 of the second thin portion 23 may be equal to or larger than a width D2 of the second thin portion 23. For example, when the length L1 of the first thin portion 13 is equal to the width D1 of the first thin portion 13, and the length L2 of the second thin portion 23 is equal to the width D2 of the second thin portion 23, a movable range R of the first connection member 10 and the second connection member 20 about an axis P1 may fall within −90 degrees≤R≤90 degrees. Further, as illustrated in FIG. 5, when the length L1 of the first thin portion 13 is greater than the width D1 of the first thin portion 13, and the length L2 of the second thin portion 23 is greater than the width D2 of the second thin portion 23, the movable range R may be widened more as compared to a case in which L=D is satisfied.

### [Method of Manufacturing Connection Structure]

Next, the method of manufacturing the connection structure 1 is described. The method of manufacturing the connection structure 1 includes a preparation step and a connection step.

As illustrated in FIG. 1 to FIG. 3, in the preparation step, the first connection member 10 including the first conductor 11 and the second connection member 20 including the second conductor 21 are prepared.

In the connection step, the first connection member 10 and the second connection member 20 are connected to each other. The connection structure 1 illustrated in FIG. 4 or FIG. 5 can be manufactured by connecting the first connection member 10 and the second connection member 20 to each other. The method of connecting the first connection member 10 and the second connection member 20 to each other is not particularly limited. As described above, the first connection surface 13a and the second connection surface 23a may be connected to each other by welding. Welding may be pressure joining such as ultrasonic welding and resistance welding, or a combination thereof.

As described above, the connection structure 1 according to the present embodiment includes the first connection member 10 including the first conductor 11 and the second connection member 20 including the second conductor 21. The first conductor 11 is a bus bar. The first conductor 11 includes the first base portion 12 and the first thin portion 13 being continuously connected to the first base portion 12 on the same plane and having a thickness smaller than that of the first base portion 12. The second conductor 21 includes the second base portion 22 and the second thin portion 23 being continuously connected to the second base portion 22 on the same plane and having a thickness smaller than that of the second base portion 22. The shape of the second thin portion 23 as viewed in the length direction X of the second conductor 21 is a rectangular shape. The first thin portion 13 is provided at the distal end of the first conductor 11, and the thickness of the first thin portion 13 is smaller than that of the first base portion 12 throughout the width direction Y of the first conductor 11. The second thin portion 23 is provided at the distal end of the second conductor 21, and the thickness of the second thin portion 23 is smaller than that of the second base portion 22 throughout the width direction Y of the second conductor 21. The first thin portion 13 includes the first connection surface 13a arranged on a plane different from the first surface 12a of the first base portion 12. The second thin portion 23 includes the second connection surface 23a arranged on a plane different from the first surface 22a of the second base portion 22. The first connection surface 13a and the second connection surface 23a contact with each other to connect the first connection member 10 and the second connection member 20 to each other.

In the connection structure 1 according to the present embodiment, the first conductor 11 includes the first thin portion 13, and the second conductor 21 includes the second thin portion 23. Further, the first connection surface 13a of the first thin portion 13 and the second connection surface 23a of the second thin portion 23 contact with each other to connect the first connection member 10 and the second connection member 20 to each other. Thus, the thickness of the connection part 33 between the first connection member 10 and the second connection member 20 can be reduced.

Further, in the connection structure 1 according to the present embodiment, the first thin portion 13 is provided at the distal end of the first conductor 11, and the thickness of the first thin portion 13 is smaller than that of the first base portion 12 throughout the width direction Y of the first conductor 11. Further, the second thin portion 23 is provided at the distal end of the second conductor 21, and the thickness of the second thin portion 23 is smaller than that of the second base portion 22 throughout the width direction Y of the second conductor 21. With this configuration, the connection angle between the first connection member 10 and the second connection member 20 is not regulated, and the connection direction of the first connection member 10 and the second connection member 20 can be prevented from being fixed.

Therefore, according to the connection structure 1 according to the present embodiment, the connection angle between the first connection member 10 and the second connection member 20 can be adjusted freely while suppressing an increase in thickness of the connection part 33 between the first connection member 10 and the second connection member 20.

Further, an appropriate adhesive force is required between the bus bar and the insulating coating material. When the adhesive force is low, a wrinkle or a crack may be generated in the insulating coating material at the time of bending of the bus bar, and there may be a risk that the insulation performance of the insulating coating material cannot be secured appropriately. In contrast, when the adhesive force is excessively high, it is difficult to remove the insulating coating material from the conductor. However, in the connection structure 1 according to the present embodiment, the bus bar does not require bending. Therefore, it is sufficient to ensure an adhesive force that allows the bus bar and the insulating coating material to be in overall contact and prevents separation, thereby mitigating the risk of reduced insulation performance. Further, when a flexible insulating coating material is used, and the bus bar is subjected to bending, the thickness of the insulating coating material at the bent part is reduced, and there may be a risk that the insulation performance and durability cannot be maintained sufficiently. However, in the connection structure 1 according to the present embodiment, the bus bar does not require bending, and hence a wide variety of insulating coating materials including an insulating coating material more flexible than those in the related art can also be used.

Further, when the bus bar is bent, the cross-sectional area of the bent part is reduced, heat generation due to Joule heating may increase, and vibration durability may be degraded. However, in the connection structure 1 according to the present embodiment, the first connection member 10 or the second connection member 20 does not require bending, and hence a decrease in vibration durability can be suppressed.

Further, according to the connection structure 1 according to the present embodiment, the connection angle between the first connection member 10 and the second connection member 20 can be adjusted freely. Thus, a bus bar having a straight shape may be manufactured, and the first connection member 10 and the second connection member 20 may be connected to each other at a desired angle as required. Thus, as compared to a bus bar subjected to bending, the bus bar having a straight shape can reduce an empty space in a transport case and reduce a packaging size. As a result, shipping cost can be reduced.

The second conductor 21 may be a bus bar or an element wire bundle including a plurality of element wires. Even when the first conductor 11 is a bus bar, and the second conductor 21 is a bus bar or an element wire bundle, the first connection member 10 and the second connection member 20 can be connected to each other.

The first thin portion 13 may include the first arc portion 13c, and the second thin portion 23 may include the second arc portion 23c. With this configuration, the distal end of the first thin portion 13 can be prevented from interfering with the second base portion 22, and the distal end of the second thin portion 23 can be prevented from interfering with the first base portion 12. Thus, the connection direction of the first connection member 10 and the second connection member 20 can be adjusted easily.

The first connection surface 13a and the second connection surface 23a may be connected to each other by welding. In the connection structure 1 according to the present embodiment, the connection method is not limited to ultrasonic welding, and various methods may be adopted. However, the first connection member 10 and the second connection member 20 can be connected easily to each other by connecting the first connection surface 13a and the second connection surface 23a to each other by welding.

The length L1 of the first thin portion 13 may be equal to or larger than the width D1 of the first thin portion 13, and the length L2 of the second thin portion 23 may be equal to or larger than the width D2 of the second thin portion 23. With this configuration, the connection angle between the first connection member 10 and the second connection member 20 can be increased. Thus, the connection angle between the first connection member 10 and the second connection member 20 can be adjusted more freely.

As described above, the method of manufacturing the connection structure 1 according to the present embodiment includes a step of preparing the first connection member 10 including the first conductor 11 and the second connection member 20 including the second conductor 21, and a step of connecting the first connection member 10 and the second connection member 20 to each other. The first conductor 11 is a bus bar. The first conductor 11 includes the first base portion 12 and the first thin portion 13 being continuously connected to the first base portion 12 on the same plane and having a thickness smaller than that of the first base portion 12. The second conductor 21 includes the second base portion 22 and the second thin portion 23 being continuously connected to the second base portion 22 on the same plane and having a thickness smaller than that of the second base portion 22. The shape of the second thin portion 23 as viewed in the length direction X of the second conductor 21 is a rectangular shape. The first thin portion 13 is provided at the distal end of the first conductor 11, and the thickness of the first thin portion 13 is smaller than that of the first base portion 12 throughout the width direction Y of the first conductor 11. The second thin portion 23 is provided at the distal end of the second conductor 21, and the thickness of the second thin portion 23 is smaller than that of the second base portion 22 throughout the width direction Y of the second conductor 21. The first thin portion 13 includes the first connection surface 13a arranged on a plane different from the first surface 12a of the first base portion 12. The second thin portion 23 includes the second connection surface 23a arranged on a plane different from the first surface 22a of the second base portion 22. In the connection structure 1, the first connection surface 13a and the second connection surface 23a contact with each other to connect the first connection member 10 and the second connection member 20 to each other.

Therefore, it is possible to manufacture the connection structure 1 that can freely adjust the connection angle between the first connection member 10 and the second connection member 20 while suppressing an increase in thickness of the connection part 33 between the first connection member 10 and the second connection member 20.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connection structure comprising:
a first connection member including a first conductor; and
a second connection member including a second conductor, wherein
the first conductor is a bus bar,
the first conductor includes a first base portion and a first thin portion being continuously connected to the first base portion on the same plane and having a thickness smaller than that of the first base portion,
the second conductor includes a second base portion and a second thin portion being continuously connected to the second base portion on the same plane and having a thickness smaller than that of the second base portion,
a shape of the second thin portion as viewed in a length direction of the second conductor is a rectangular shape,
the first thin portion is provided at a distal end of the first conductor, and a thickness of the first thin portion is smaller than that of the first base portion throughout a width direction of the first conductor,
the second thin portion is provided at a distal end of the second conductor, and a thickness of the second thin portion is smaller than that of the second base portion throughout a width direction of the second conductor,
the first thin portion includes a first connection surface arranged on a plane different from a surface of the first base portion,
the second thin portion includes a second connection surface arranged on a plane different from a surface of the second base portion, and
the first connection surface and the second connection surface contact with each other to connect the first connection member and the second connection member to each other.

2. The connection structure according to claim 1, wherein
the second conductor is a bus bar or an element wire bundle including a plurality of element wires.

3. The connection structure according to claim 1, wherein
the first thin portion includes a first arc portion, and the second thin portion includes a second arc portion.

4. The connection structure according to claim 1, wherein
the first connection surface and the second connection surface are connected to each other by welding.

5. The connection structure according to claim 1, wherein
a length of the first thin portion is equal to or larger than a width of the first thin portion, and a length of the second thin portion is equal to or larger than a width of the second thin portion.

6. A method of manufacturing a connection structure, the method comprising:
preparing a first connection member including a first conductor and a second connection member including a second conductor; and
connecting the first connection member and the second connection member to each other, wherein
the first conductor is a bus bar,
the first conductor includes a first base portion and a first thin portion being continuously connected to the first base portion on the same plane and having a thickness smaller than that of the first base portion,
the second conductor includes a second base portion and a second thin portion being continuously connected to the second base portion on the same plane and having a thickness smaller than that of the second base portion,
a shape of the second thin portion as viewed in a length direction of the second conductor is a rectangular shape,
the first thin portion is provided at a distal end of the first conductor, and a thickness of the first thin portion is smaller than that of the first base portion throughout a width direction of the first conductor,
the second thin portion is provided at a distal end of the second conductor, and a thickness of the second thin portion is smaller than that of the second base portion throughout a width direction of the second conductor,
the first thin portion includes a first connection surface arranged on a plane different from a surface of the first base portion,
the second thin portion includes a second connection surface arranged on a plane different from a surface of the second base portion, and
in the connection structure, the first connection surface and the second connection surface contact with each other to connect the first connection member and the second connection member to each other.
